(19) United States
(12) Patent Application Publication
(10) Pub. No.: US 2008/0285956 A1
(43) Pub. Date: Nov. 20, 2008

(54) MULTIMEDIA DIGITAL VIDEO RECORDER AND PLAYER

(75) Inventors: Yu-Hua Yang, Taipei (TW); Jiun-Jie Yang, Taipei (TW)

Correspondence Address: TAIWAN VIDEO SYSTEMS CO., LTD, P.O. BOX 108-00403, TAIPEI 106, TW

(73) Assignee: TAIWAN VIDEO SYSTEM CO., LTD., Taipei (TW)

(21) Appl. No.: 11/750,337

(22) Filed: May 18, 2007

(51) Int. Cl. H04N 5/765; H04N 9/12

(52) U.S. Cl. 386/124; 386/E05.001

(57) ABSTRACT

A multimedia digital video recorder and player capable of recording/playing audio and video while detecting a place is disclosed comprising a display on the outside wall for audio and video output, a digital video recorder and player module, which comprises a memory unit for storing data, a control interface for the connection of an external control device for system operation control, a signal processing unit for receiving and processing/editing signals obtained from video cameras connected thereto for display on the display and storage in the memory unit, an external signal interface for input of external audio/video signals from external signal storage devices, a multimedia player module, which comprises an audio/video decoder for editing audio and video signals received from the external signal sources and outputting edited audio and video signals to the display through an audio/video interface thereof for play.

### BACKGROUND OF THE INVENTION

1. Field of the Invention

The present invention relates to a digital video recorder and player and more particularly, to a multimedia digital video recorder and player, which is controllable to detect abnormal conditions in a place and to record/play audio video during detection.

2. Description of the Related Art

In our living environment, unexpected conditions happen frequently. When an unexpected condition happened, a proper handling procedure should be enforced immediately to prevent serious consequences. For example, when a gas leakage, fire, intrusion of evil or any other unexpected condition happens, people may suffer a financial loss, property damage or body injury. Further, burglary, robbery, fighting and killing cases usually occur in public places. How to prevent these cases? One of the best ways is to install a security system. A security system can be installed in an assigned place to detect any abnormal changes indoors as well as outdoors, and to trigger an alarm when an abnormal condition is detected.

A regular CC-TV security system uses a tape recorder to record video signal obtained from the connected video cameras. Because a tape recorder for a regular CC-TV security system adopts simulation model, its resolution is not high. Further, a video tape for a taper recorder cannot record much video data. Therefore, the video tape of the tape recorder of a CC-TV security system must be frequently replaced. Further, a CC-TV security system uses many cables to connect video cameras, video monitors and other peripheral apparatus to the host unit. Further, the operation of a CC-TV security system must be controlled by means of the buttons at the face panel of the host unit. In actual practice, the use of a CC-TV security system has the following drawbacks:
1. The host unit has neither image storage means for storing monitored image signal directly nor transmission interface means for transmitting monitored image signal to an external memory. Using a tape recorder to record monitored image signal is inconvenient. The user must frequently replace the video tape because it can only record image signal for about one hour.
2. The host unit can only record monitored image signal in a video tape. For viewing monitored image signal recorded in a video tape, the user must use a video player to play the video tape. In case of emergency, the best chance to handle the case may be missed.
3. The host unit does not have any built-in memory device for recording monitored image data. When the connected tape recorder fails or the video tape is used up, the image recording function is stopped, reducing the protection.

In the present digital era, the conventional analog image processing method has been gradually replaced by digital image processing methods. The creation of DVR (Digital Video Recorder) greatly expands the functioning of a monitoring system. A digital video recorder allows transmission of recorded digital video signal to an external display or data storage device either through a cable or network, or wirelessly. A DVR has built-in hard disk drive for recording digital image data. However, the data storage capacity is limited. Further, a DVR does not allow for real time data access. Data access and recording must be separately operated. A DVR also does not allow connection of an external memory card, memory stick or hard disk drive. When viewing the recorded digital image data, an external video monitor must be used. The installation of an external video monitor requires much space and cost. Further, certain digital video recorders have a complicated control system with multiple operation buttons. For controlling complicated digital video recorders, a MIS (Management Information System) may have to be used with a computer for operation control by a skilled or well-trained person.

In general, the use of a digital video recorder in a security system has many drawbacks as follows:

1. Because a digital video recorder in a security system works 24 hours a day, the service life of the built-in hard disk drive is greatly shortened (normally about 3˜4 months). Changing the built-in hard disk drive is complicated.

2. A regular digital video recorder for security system does not allow for playing audio/video when recording monitored image data. For playing audio/video, a video monitor and a video player must be installed. The installation of these devices requires much extra space.

3. A regular digital video recorder for security system has only one single operation control interface with multiple control buttons. The use of this kind of digital video recorder requires a training course or learning step.

Therefore, it is desirable to provide a multimedia digital video recorder and player that eliminates the aforesaid problems.

### SUMMARY OF THE INVENTION

The present invention has been accomplished under the circumstances in view.

According to one aspect of the present invention, the multimedia digital video recorder and player is comprised of a display for audio and video signal output, a digital video recorder and player module and a multimedia player module. The digital video recorder and player module comprises a central processing unit, a memory unit electrically connected to the central processing unit for storing data, a control interface electrically connected to the central processing unit for the connection of an external control device for controlling the operation of the central processing unit, a signal processing unit electrically connected to the central processing unit for receiving audio/video signals from external signal source means and editing received audio/video signals, the signal processing unit comprising a signal converter for converting analog signals into digital signals, a signal transmission interface electrically connected between the central processing unit and the display and controllable by the central processing unit for output to the display, and an external signal interface electrically connected to the central processing unit for input of external audio/video signals from external signal storage means. The multimedia player module is mounted on one side of the digital video recorder and player module and electrically connected to the central processing unit, comprising an audio/video decoder electrically connected to the central processing unit for editing audio and video signals and an audio/video interface electrically connected to the display for audio and video signal output. The human engineered design of the multimedia digital video recorder and player is convenient for operation control. The external control device can be a mouse, keyboard or remote controller. Touch screen may be provided for clicking to select the monitoring mode or playing mode.

According to another aspect of the present invention, the memory unit can be a built-in hard disk drive or mobile hard disk drive. Further, the external signal interface can be a memory card slot for the connection of a memory card, a USB interface for the connection of a USB compatible multimedia player or a network interface for the connection of a network.

### BRIEF DESCRIPTION OF THE DRAWINGS

FIG. 1 is a system block diagram of a multimedia digital video recorder and player according to the present invention.

FIG. 2 is a circuit block diagram of the multimedia digital video recorder and player according to the present invention.

FIG. 3 is a circuit block diagram of a part of the multimedia digital video recorder and player according to the present invention.

FIG. 4 is a circuit block diagram of a part of the multimedia digital video recorder and player according to the present invention.

FIG. 5 is a system block diagram of an alternate form of the multimedia digital video recorder and player according to the present invention.

FIG. 6 is a circuit block diagram of a part of the multimedia digital video recorder and player according to the alternate form of the present invention.

### DETAILED DESCRIPTION OF THE PREFERRED EMBODIMENT

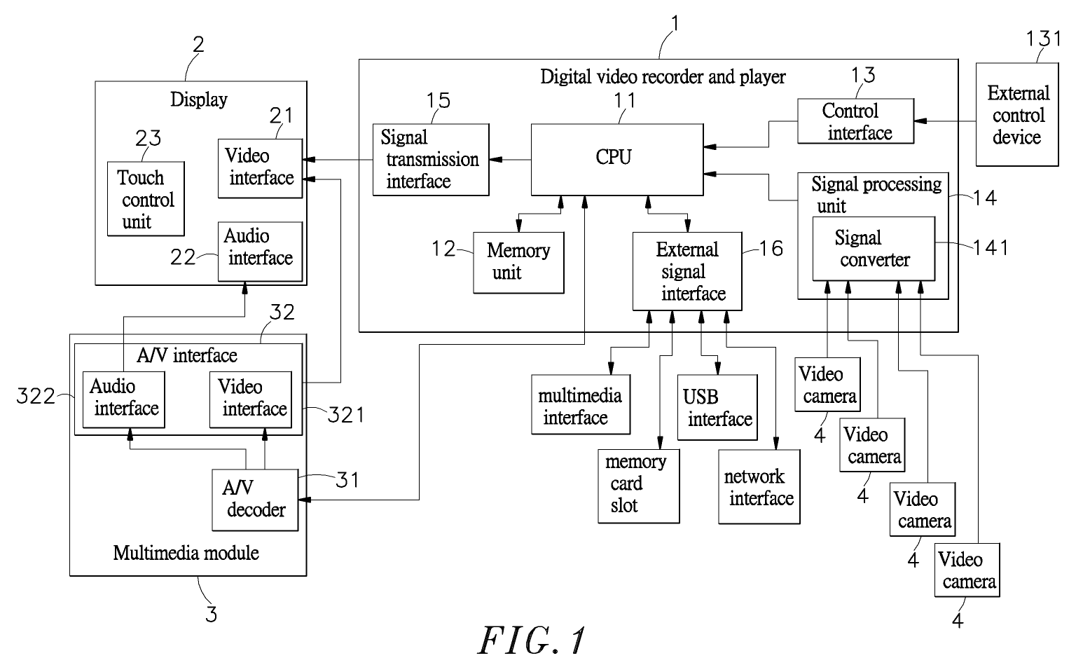

Referring to FIGS. 1˜4, a multimedia digital video recorder and player in accordance with the present invention is generally comprised of a digital video recorder and player module 1, a display 2 and a multimedia module 3.

The digital video recorder and player module 1 comprises a CPU 11 for video editing and control, a memory unit 12 electrically connected to the CPU 11 for storing data, a control interface 13 electrically connected to the CPU 11 for the connection of an external control device 131, a signal processing unit 14 electrically connected to the CPU 11 and having a signal converter 141 for signal format conversion, and a signal transmission interface 15 electrically connected to the CPU 11 for transmitting video signal, and an external signal interface 16 electrically connected to the CPU 11 for input of external signal from an external signal source.

The display 2 comprises a video interface 21 an audio interface 22.

The multimedia player module 3 comprises an A/V decoder 31 capable of editing audio and video signals, and an A/V interface 32. The A/V interface 32 comprises a video interface 321 electrically connected to the video interface 21 of the display 2, and an audio interface 322 electrically connected to the audio interface 22 of the display 2.

The signal transmission interface 15 of the digital video recorder and player module 1 is electrically connected to the video interface 21 of the display 2 to transmit video signals from video cameras 4 to the display 2 for image display.

The external signal interface 16 can be a multimedia (CD-ROM, DVD-ROM, memory card slot, A/V recorder/player) interface, USB interface, RS485 interface, RS232 interface or network interface adapted to receive an external A/V signal source and to transmit an external A/V signal from the connected external A/V signal source to the CPU 11, for enabling the CPU 11 to transmit the received external A/V signal to the multimedia player module 3. Upon receipt of the external A/V signal from the CPU 11, the A/V decoder 31 of the multimedia player module 3 decodes the external A/V signal, and then the video interface 321 and the audio interface 322 of A/V interface 32 transmit the decoded video signal and the decoded audio signal to the video interface 21 and the audio interface 22 of the display 2 for output. Thus, when the display 2 is playing video signals received by the CPU 11 from the connected video cameras 4, the CPU 11 synchronously receives an external A/V signal from the connected external A/V signal source and transmits the received external A/V signal to the multimedia player module 3, which decodes the received external A/V signal and transmits the decoded video signal and the decoded audio signal to the video interface 21 and the audio interface 22 of the display 2 for output. Therefore, the multimedia digital video recorder and player of the present invention provides an audio/video player function while running a screen recording and monitoring function.

The A/V decoder 31 of the multimedia player module 3 is designed to decode or encode format signals, such as MPEG4 VIDEO, MPEG2 MOVIE, MPEG1 VIDEO, MOTION JPEG and JPEG PHOTO, and audio format signals, such as S/PD IF DIGITAL AUDIO, ACC AUDIO, AC-3 AUDIO, MP3 MUSIC and ESS MUSIC, thereby fitting the play format of the display 2.

Further, the CPU 11 of the digital video recorder and player module 1 has a built-in compression function, and the compression format can be MotionJPEG, MPEG4 or H.264.

The A/V data obtained from each connected video camera 4 is processed by the signal processing unit 14 and then transmitted to the CPU 11 for storing in the memory unit 12. The user can fetch storage video data from the memory unit 12 through the CPU 11, and send the fetched video data through the external signal interface 16 to an external data storage means for storage.

The external control device 131 that is connected to the control interface 13 can be a mouse, keyboard, remote controller or control buttons on the surface of the digital video recorder and player module 1. The control buttons are human factor engineered for convenient operation. Through the external control device 131, the user can directly click the operation interface displayed on the screen of the display 2, thereby controlling the operation of the digital video recorder and player module 1. This control operation is simple and convenient. An ordinary, non-professional person uses the system. It is not necessary to install a MIS (Management Information System) to control the operation of the digital video recorder and player module 1. Through the external control device 131, a non-professional person can control the operation of the digital video recorder and player module 1 conveniently. Further, the signal converter 141 of the signal processing unit 14 can be an A/D (Analog/Digital) converter that processes image signal from each video camera 4 connected thereto, i.e., converts analog image signal into digital image signal and then transmits the converted digital image signal to the memory unit 12 for storage and to the display 2 through the signal transmission interface 15 for display under the control of the CPU 11. The memory unit 12 can be comprised of a built-in or internal HDD (Hard Disk Drive) memory card, or any of a variety of data storage devices for storing image data obtained from the connected video cameras 4. As stated above, the external signal interface 16 can be a multimedia (CD-ROM, DVD-ROM, memory card slot, A/V recorder/player) interface, USB interface, RS485 interface, RS282 interface or network interface adapted to receive an external A/V signal source and to transmit an external A/V signal from the connected external A/V signal source to the CPU 11, for enabling the CPU 11 to transmit the received external A/V signal to the multimedia player module 3. The memory card slot is designed to receive SD/MS card, CF card, and SM/XD card. The USB interface is for the connection of the USB connector of an external mobile memory stick, hard disk drive, MP3 player, MP4 player, multimedia storage device or the like. By means of the external signal interface 16, the user can expand the memory capacity of the multimedia digital video recorder and player and make a copy of video data obtained from the connected video cameras 4 in an external storage device. The external signal interface 16 can be a network interface, Land Viewer or RJ45 for the connection of a remote computer through a network for remote monitoring.

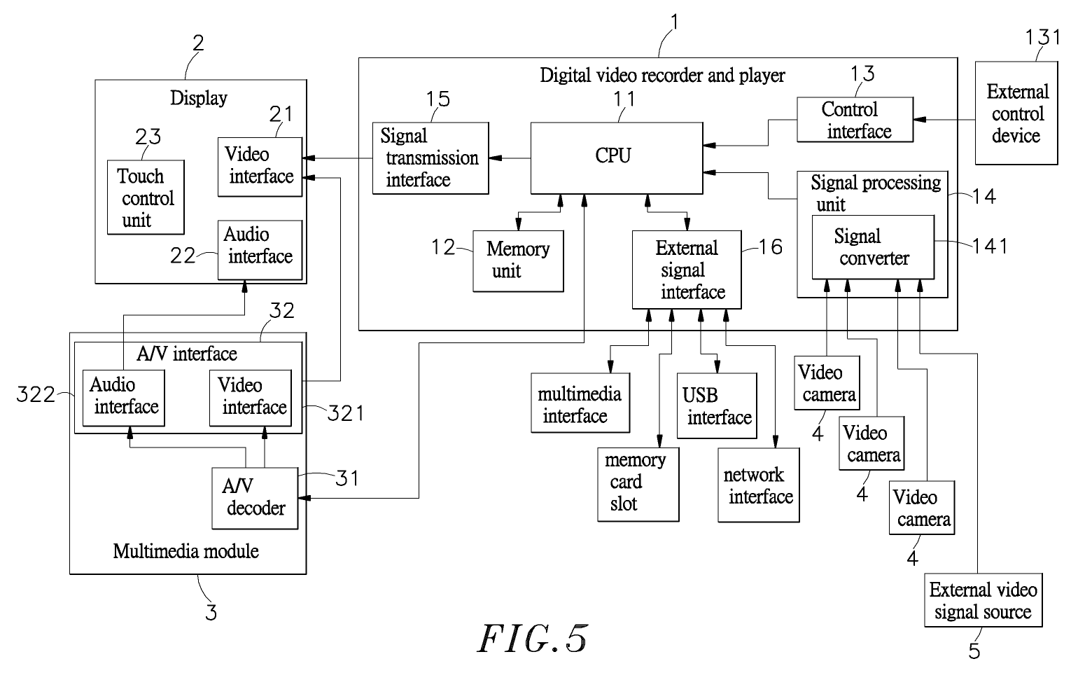

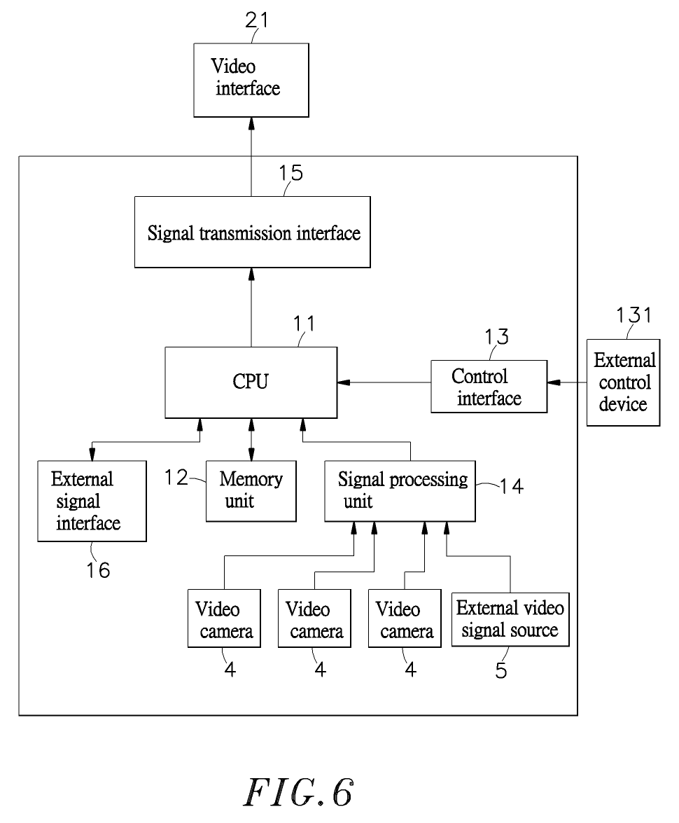

Referring to FIGS. 5 and 6, in addition to the connection of video cameras 4, the signal converter 141 of the signal processing unit 14 allows for the connection of an external video signal source (analog or digital TV signal) 5 through a coaxial cable. The signal processing unit 14 has a built-in video decoder that decodes video signal from the connected external video signal source 5 into the format of the display 2, for enabling the decoded video signal to be transmitted by the CPU 11 through the signal transmission interface 15 to the display 2 for display.

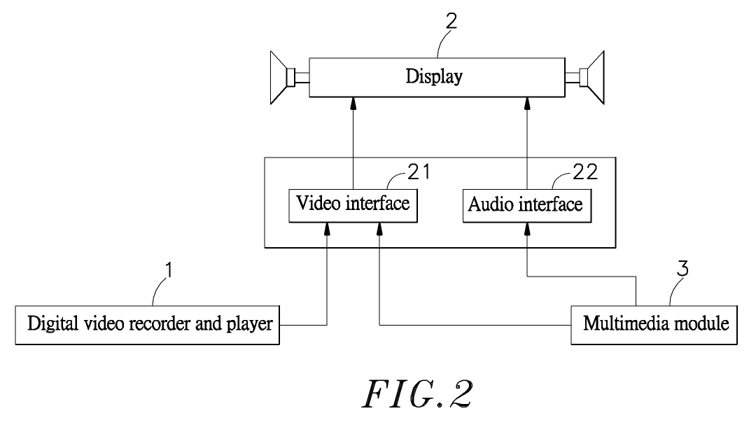

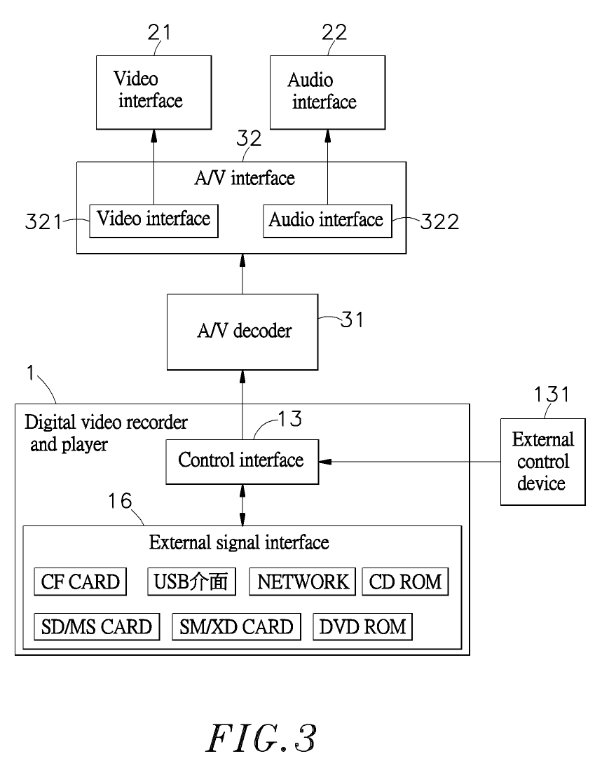

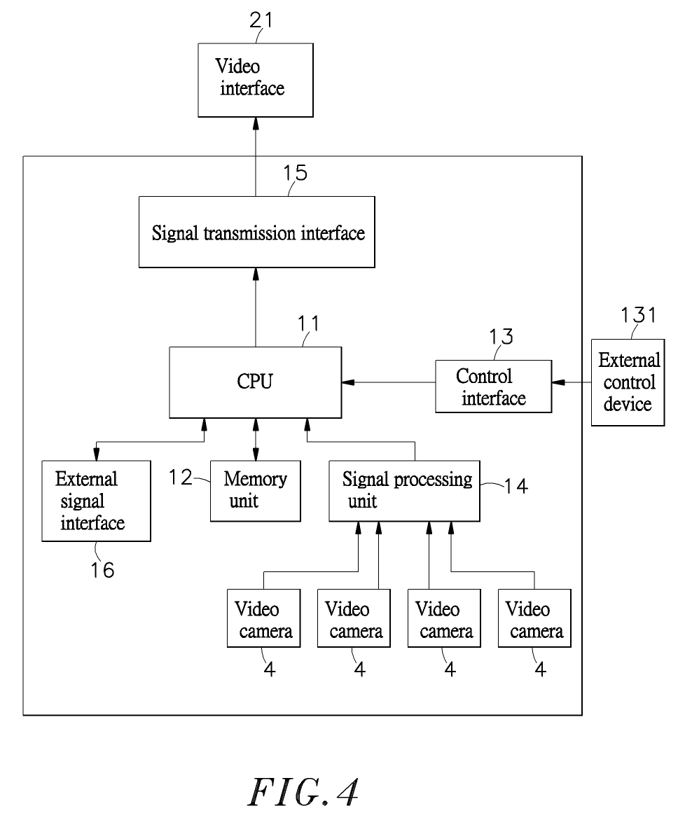

Referring to FIGS. 1-4 again, by means of the built-in network interface or Land Viewer, a person at a remote site can monitor the multimedia digital video recorder and player through a network, for example, the Internet. The digital video recorder and player module 1 can be designed having an image display editing interface so that the control person can edit the images displaying on the display 2 (such as, split image, PIP/POP, replay, etc.). By means of the external control device 131 (mouse, keyboard, remote controller, etc.), the user can directly click the operation interface displayed on the screen of the display 2 to control the operation of the digital video recorder and player module 1. This control operation is simple and convenient. The display unit 2 may be designed to provide an UI (User Interface) for operation control. By means of the external control device 131 (mouse, keyboard, remote controller, etc.), the user can click the function options on the UI. Therefore, old or young people who are not familiar with electronic device can operate the multimedia digital video recorder and player conveniently. The digital video recorder and player module 1 may be provided with a trigger interface such that the CPU 11 outputs a trigger signal through the external signal interface 16 to trigger an external security/alarm system when the monitored signal differs from the predetermined reference level.

When an external multimedia player is connected to the external signal interface 16 of the digital video recorder and player module 1, the user can operate the external control device 131 of the digital video recorder and player module 1 to control the CPU 11 through the control interface 13, enabling the output A/V signal of the multimedia player to be transmitted to the display 2 for output. The display 2 can be a touch screen display built in the digital video recorder and player module 1, having a touch control unit 23 for touch control. By means of the touch control unit 23, the user can directly click the display 2 to control the operation of the digital video recorder and player module 1 without through the external control device 131. By means of the external signal interface 16, an external multimedia player, such as, DVD-ROM, VCD-ROM, CD-ROM, MEDIA PLAYER, digital video recorder/player, burner, etc., can be connected to the digital video recorder and player module 1 for recording video data stored in the memory unit 12, obtained from the connected video cameras 4 or playing audio and video on the display 2.

As indicated above, the invention provides a multimedia digital video recorder and player comprising a digital video recorder and player module 1, a display 2 and a multimedia player module 3. The digital video recorder and player module 1 comprises an image processing unit 14 for processing video signals from connected external video cameras 4 and/or connected TV video signal source for display on a built-in display 2 subject to the control of a CPU 11 as well as for storage in a memory unit 12, and an external signal interface 16 for transmitting external A/V signal from an external A/V signal source to a built-in multimedia player module 3 for output through the display 2 after processing through an A/V decoder 31 in the multimedia player module 3. By means of the external signal interface 16, video data obtained from the connected video cameras 4 can be stored in an external data storage means.

As stated above, the multimedia digital video recorder and player of the present invention has the following features and advantages:

1. By means of the control of the CPU 11, images obtained from the connected video cameras 4 and processed through the signal processing unit 14 can be transmitted through the signal transmission interface 15 to the video interface 21 of the display 2 for display on the screen of the display 2.

2. Audio and/or video signals obtained from the connected video cameras 4 can be stored in the memory unit 12 or an external data storage means that is connected to the external signal interface 16. By means of the external signal interface 16, a multimedia player can be connected to the digital video recorder and player module 1 to fetch storage data from the memory unit 12 for making a backup.

3. The display 2 and the multimedia player module 3 are built in the digital video recorder and player module 1, eliminating the wire tangling problem. The external signal interface 16 allows for the connection of an external data storage device, such as memory card, memory stick, mobile hard disk drive, or a computer or electronic device having data storage means directly or through the Internet.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A multimedia digital video recorder and player for recording and playing audio and video signals, comprising:
a display for audio and video signal output;
a digital video recorder and player module, said digital video recorder and player module comprising a central processing unit, a memory unit electrically connected to said central processing unit for storing data, a control interface electrically connected to said central processing unit for the connection of an external control device for controlling the operation of said central processing unit, a signal processing unit electrically connected to said central processing unit for receiving audio/video signals from external signal source means and editing received audio/video signals, said signal processing unit comprising a signal converter for converting analog signals into digital signals, a signal transmission interface electrically connected between said central processing unit and said display and controllable by said central processing unit for output to said display, and an external signal interface electrically connected to said central processing unit for input of external audio/video signals from external signal storage means; and
a multimedia player module mounted on one side of said digital video recorder and player module and electrically connected to said central processing unit, said multimedia player module comprising an audio/video decoder electrically connected to said central processing unit for editing audio and video signals and an audio/video interface electrically connected to said display for audio and video signal output.

2. The multimedia digital video recorder and player as claimed in claim 1, wherein said central processing unit, said multimedia player module and said audio/video decoder are respectively formed of a single chip.

3. The multimedia digital video recorder and player as claimed in claim 1, wherein said memory unit of said digital video recorder and player module is selected from a group of data storage devices including built-in hard disk drives, memory cards, mobile hard disk drives and memory sticks.

4. The multimedia digital video recorder and player as claimed in claim 1, wherein said signal processing unit of said digital video recorder and player module is adapted to encode and decode video signals, said signal converter of said signal processing unit is adapted to convert analog video signals into digital video signals.

5. The multimedia digital video recorder and player as claimed in claim 1, wherein said control device is one of the devices including computer mouse, keyboard, remote controller and touch screen.

6. The multimedia digital video recorder and player as claimed in claim 1, wherein said external signal interface is one of the devices including RS485, RS232, PS2, trigger interface, network interface, Land Viewer and USB connector.

7. The multimedia digital video recorder and player as claimed in claim 1, wherein said external signal interface is connectable is a memory card slot.

8. The multimedia digital video recorder and player as claimed in claim 7, wherein said memory card slot is compatible to SD/MS card, SM/XD card and CF card.

9. The multimedia digital video recorder and player as claimed in claim 1, wherein said external signal interface is a network interface comprised of a RJ45 interface.

10. The multimedia digital video recorder and player as claimed in claim 1, wherein said external signal interface has connected thereto a multimedia player.
